(19) United States
(12) Patent Application Publication
(10) Pub. No.: US 2003/0222987 A1
(43) Pub. Date: Dec. 4, 2003

(54) Line scan image recording device with internal system for delaying signals from multiple photosensor arrays

(76) Inventor: Paul M. Karazuba, San Carlos, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/158,384

(22) Filed: May 30, 2002

(51) Int. Cl. H04N 5/225

(52) U.S. Cl. 348/207.99

(57) ABSTRACT

The digital image recording device and method for generating a digital image includes a housing and a capturing device including a plurality of photosensors spatially separated from each other along a scan direction within the housing. Each of the plurality of photosensors is capable of sensing an image scanned across the capturing device in the scan direction and transmitting an electrical signal corresponding to the sensed image. Delay means within the housing delays at least one of the originally non-synchronous transmitted electrical signals relative to other of the transmitted electrical signals thereby synchronizing the signals. The electrical signals associated with the plurality of photosensors are therefore synchronized or delayed inside the camera housing and before the images are combined. The signals are combined to provide an undistorted image without the need for external software or computers. The image may then be stored or displayed on either an external display or an on-board display.

### BACKGROUND OF THE INVENTION

Standard film cameras are able to record images of stationary objects or a moving object frozen in time on film. Digital line scan cameras are typically used if the object to be recorded is moving relative to the camera in a straight line, or is a continuous product or “web”, such as, for example, a textile, paper, glass, or document. A “camera” within the context of this disclosure includes any type of image recording device, including, for example, a scanner.

Digital line scan cameras typically include a one-dimensional array or “line” of pixel cells. The “line” of pixel cells is typically oriented orthogonal to the scan direction and may be referred to as a photosensor. Each pixel cell generates an electrical signal based on the light detected on its surface. The object to be recorded and the line of pixel cells move relative to each other along the scan direction, in digital line scan cameras. Any scene within the field of view of the line of pixel cells may be considered an “object” for purposes of this disclosure.

As the object to be recorded is scanned across the line of pixels, frequently by a conveyer or gravity, a two dimensional image can be recorded. One spatial dimension is recorded in terms of time as the object is passed along the line of pixel cells. The resolution in this dimension therefore depends on the speed of the object and the frequency of successive captures by the line of pixel cells. The other dimension is recorded in terms of location along the line of pixels. Therefore an image with an infinite length can be recorded with a digital line scan camera. Optics, i.e. lenses, may also be used to enable larger objects to be completely sensed by a small photosensor.

To boost the signal generated by a scan, several lines of pixels are frequently placed along the scan direction of some cameras. One such camera is called a tri-linear sensor. The tri-linear sensor includes three lines of pixels. Frequently, each line is coated with a filter so that it will detect only, for instance, one of red, green, or blue light. This results in three separate images of three separate colors. The separate images associated with the respective photosensors, can then be combined or superimposed to form a multi-color image, e.g., an “RGB” image.

Another of the multi-linear sensor cameras is the time delay and integration, or “TDI” camera. TDI cameras typically include many lines of pixels, frequently near one hundred lines (photosensors). Multiple lines, or “stages” in these cameras allow the camera to be more sensitive to dimly lit or fast moving objects. Each charge generated by the successive line of pixels is added to the next line to generate a stronger electrical signal or the same electrical signal with a faster scan speed.

Problems encountered by both of these multi-linear sensor cameras arise when the images from the different lines of pixels are combined. The components of the combined images are skewed along the dimension recorded in terms of time. The leading edge of the object is exposed to the first line of pixels at an earlier time than it is exposed to the last line of pixels, as the object moves across the line-scan sensors that are spaced apart along the scan direction. Therefore, the image recorded by the first line will be displaced along the scan direction from the images recorded by each successive line (photosensor) because it was recorded at a different time by each line. The displacement distance depends on the speed at which the object is moved relative to the photosensors, the relative size of the object and the pixel, the distance of the object from the sensors, the operating speed of the camera, and the spacing between the centers of the photosensors.

Some efforts have been made to overcome these problems with multi-linear sensor cameras by exporting the uncombined signals which combine to produce the image, from the camera to a computer, where a user can synchronize the images manually or automatically (if the image was moving at a predetermined speed) through software running on the computer. However, use of such a bulky computer and software is costly, time consuming, inconvenient, and complicated, and limits the portability of the camera as well.

Prisms have also been employed to deflect different wavelengths of light received at a single location, to spatially separated photosensors. However, due to the loss of sensitivity caused by the prism, the resolution of these images tends to be low.

It would therefore be advantageous to provide a multi-linear sensor camera capable of internally synchronizing or delaying the separate signals without requiring the use of a prism or an external connection to a computer or the like.

### SUMMARY OF THE INVENTION

To address these and other needs, and in view of its purposes, the present invention provides a digital image recording device including a housing containing a capturing device including a plurality of photosensors spatially separated from each other along a scan direction within the housing. Each of the plurality of photosensors is capable of sensing an object scanned across the capturing device. Each photosensor is further capable of transmitting an electrical signal corresponding to the sensed object, and delay means within the housing are provided for delaying at least one of the transmitted electrical signals relative to another of the transmitted electrical signals. The electrical signals associated with the plurality of photosensors are therefore synchronized or delayed inside the housing and before they are combined to form an image. The combined signals provide an undistorted image without the need for external software or computers. This image may be stored or displayed either on an external display or an on-board display.

A further embodiment of the invention includes an interface through which the delay of at least one selected signal can be programmed by, for example, a user or software. In this manner, the delay can be dynamically changed consistent with the speed, direction, or size of the object, the size of the pixels of the photosensors, the distance between the object and the capturing device, and/or the operating speed of the camera.

In a further embodiment, the invention provides a digital camera comprising a camera housing containing a capturing device including a plurality of photosensors spatially separated from each other along a scan direction. Each of the plurality of photosensors is capable of sensing an image scanned across the capturing device in the scan direction and transmitting an electrical signal corresponding to the sensed image. Synchronizing means are included within the housing for synchronizing the transmitted electrical signals, and an image combiner capable of combining the transmitted electrical images to form a generated image is also included.

According to still a further embodiment, the invention provides a method for generating a digital image. The method includes providing a housing that contains a delay means and a plurality of photosensors that are spatially separated, scanning an object across a field of view of each of the plurality of photosensors, generating, within the housing, a plurality of electrical signals corresponding to the plurality of photosensors and associated with the object, delaying at least one of the plurality of electrical signals within the housing, and combining the plurality of electrical signals after the at least one of the plurality of electrical signals is delayed.

A further embodiment of the invention includes programming selective delay of particular signals and the delay time.

In yet a further embodiment, the invention provides a method for generating a digital image. The method includes providing a camera including a housing, the housing containing a signal synchronizer and a plurality of photosensors that are spatially separated; scanning an object across a field of view of each of the plurality of photosensors; and, generating, within the housing, a plurality of non-synchronous electrical signals corresponding to the plurality of photosensors and associated with the object. The method further comprises synchronizing the plurality of electrical signals within the housing and combining the plurality of synchronized electrical signals.

These and other advantages will be evident from the following detailed description.

### BRIEF DESCRIPTION OF THE DRAWINGS

The present invention is best understood from the following detailed description when read in conjunction with the accompanying drawings. It is emphasized that, according to common practice, the various features of the drawings are not to scale. On the contrary, the dimensions of the various features and the relative dimensions and locations of the features may be expanded or reduced for clarity. Included are the following figures.

FIG. 1 is a schematic/block diagram of one embodiment of the invention;

FIG. 2 is a plan view of an exemplary photosensor array of the invention;

FIG. 3 is a schematic diagram showing the signal processing of one embodiment of the invention;

FIG. 4a shows an exemplary displaced image formed by combining the respective images of individual sensors, before processing by the memory recombination controller; and

FIG. 4b shows an exemplary undistorted image formed by combining the respective images of individual sensors following processing by the memory recombination controller of the invention.

Like numerals denote like features throughout the specification and drawings.

### DETAILED DESCRIPTION

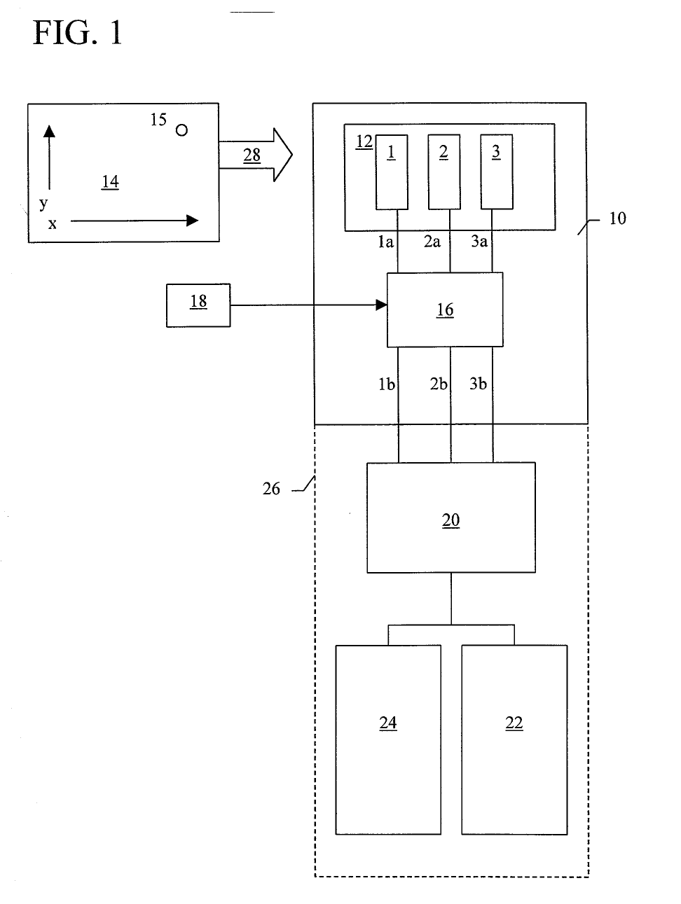

The invention provides a digital image recording device such as a high speed digital color line scan camera or the like. FIG. 1 is a schematic/block diagram illustrating the concepts of an exemplary embodiment of the digital image recording device of the invention. FIG. 1 shows a housing 10 containing an image capturing device 12 and a memory recombination controller 16 capable of receiving input commands 18. Image capturing device 12 is capable of sensing object 14 which moves relative to image capturing device 12. FIG. 1 also shows image combiner 20, storage 24, and display 22 which may be located external to the housing 10 as in the illustrated embodiment, or in or on housing 10 in other exemplary embodiments as indicated by dashed line 26. Unprocessed signals 1a, 2a and 3a are delivered from the image capturing device 12 to the memory recombination controller 16 and processed signals 1b, 2b and 3b are delivered from the memory recombination controller 16 to the image combiner 20. In an exemplary embodiment, housing 10 may be a camera housing, and the digital image recording device may be a camera.

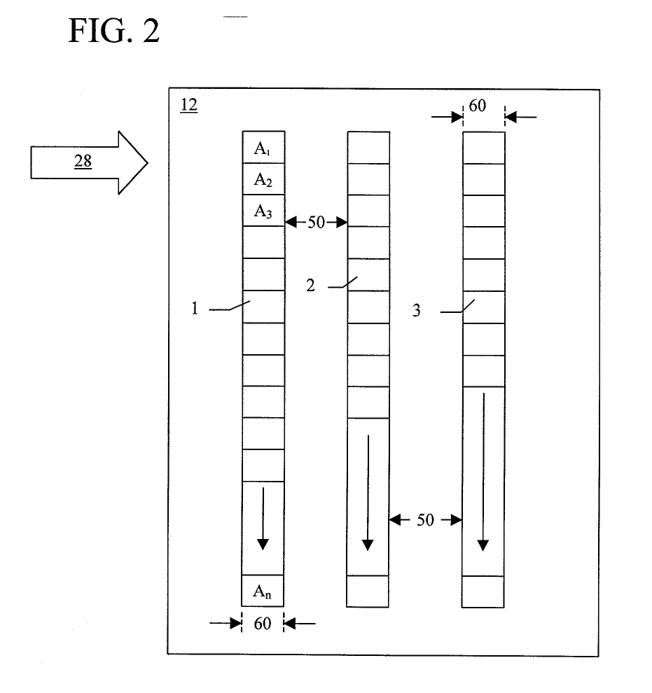

The image capturing device 12 is shown in more detail in FIG. 2. Image capturing device 12 includes three linear image photosensors 1, 2, 3, that are spatially separated by spacing 50 along direction 28 which is the scan direction in the illustrated embodiment. Each linear photosensor 1, 2, 3, may be a substantially linear array of image pixel cells, such as pixel cells A₁-Aₙ of linear photosensor 1. A “linear” array is a 1 by n array, where n is a finite integer, and may be referred to as a “line” of pixel cells. In an exemplary embodiment, each photosensor may be a charge coupled device including a plurality of linearly arranged photosensor image resolution pixels. Each of photosensors 1, 2, 3 has a width 60. In one exemplary embodiment, each width 60 may be substantially the same and each spacing 50 may be substantially the same. It is also within the scope of the invention, however, that the image capturing device 12 includes any plural number of linear photosensors in various arrangements and with various absolute and relative pixel cell widths 60 and spacings 50 between the photosensors.

In various exemplary embodiments, it may be advantageous to dedicate one or more of the photosensors to detecting a single color. To accomplish this, one or all of linear photosensors 1, 2, 3, may be coated with a color selective filter. Other types of photosensors formed to sense a single color, may be used in other exemplary embodiments. In one exemplary embodiment, each photosensor may be dedicated to sensing a particular color. For example, photosensor 1 may be formed to detect only red light, photosensor 2 may be formed to detect only green light, and photosensor 3 may be formed to detect only blue light, if such a separation of colors is desired. The images may later be combined to form an “RGB” image. By providing an image capturing device 12 including photosensors dedicated to sensing red, green and blue light, each of the colors of the spectrum may be sensed and produced by combining the outputs of the photosensors.

Returning to FIG. 1, object 14 is provided and moves with respect to image capturing device 12 along direction 28 substantially perpendicular to each of linear photosensors 1, 2, 3. It is also within the scope of the invention that an object is moved in other directions such as the direction opposite direction 28. Object 14 may be a document, line of produce, falling grains of rice, paper, etc., and relative motion may be provided, for example, by a conveyer belt, a document feed, gravity, or movement within the camera of the photosensors in a direction opposite the scan direction. Using conventional terminology, object 14 scans past photosensors 1, 2, 3 of image capturing device 12. In this example, at any given instant of time, only part of object 14 is within the field of view of any particular photosensor 1, 2, 3. Object 14 may be considered to include the totality of the various fields that will be sensed by the photosensors 1, 2, 3.

Object 14 has an x dimension along the illustrated x axis, running generally parallel to direction 28, and a y dimension along the illustrated y axis, running generally perpendicular to direction 28.

At any given instant of time, only part (a slice along the y direction) of image 14 is within the field of view of any particular photosensor 1, 2, 3 as object 14 scans past image capturing device 12. Each linear photosensor 1, 2, 3 generates an electrical signal 1a, 2a, 3a, respectively, corresponding to the scene it senses and captures as the object 14 is moved across the linear photosensors 1, 2, 3. The scene along the y axis of object 14 is simultaneously captured by each linear photosensor 1, 2, 3 when it successively scans past the photosensor. The scene along the x axis of object 14 is captured with respect to time, on linear photosensors 1, 2, 3. Due to the spatial separation of the linear photosensors 1, 2, 3, and the relative motion between object 14 and image capturing device 12, any particular point, such as exemplary point 15 of the object 14 will be captured by each photosensor 1, 2, 3 at a different time. Photosensors 1, 2, 3, convert the captured optical image into electrical signals 1a, 2a and 3a, respectively. If each of the photosensors 1, 2, 3, convert the captured optical image into an electrical signal at the same rate, electrical signals 1a, 2a, 3a, will therefore be “non-synchronous” when transmitted from the image capturing device 12. If an image is formed of these unprocessed electrical signals 1a, 2a and 3a, it will include distortion as the components represented by the signals 1a, 2a and 3a, are skewed with respect to one another.

These digital signals 1a, 2a, 3a are received by the memory recombination controller 16, which may be a field-programmable gate array (“FPGA”) or may include multiple FPGA's. In another exemplary embodiment, memory recombination controller 16 may be or include a buffer such as a FIFO buffer. Memory combination controller 16 may include any of various suitable buffers capable of inputting a delay in a digital signal. In other exemplary embodiments, memory recombination controller 16 may include, for example, a dual port RAM, multiple memory buffers, or ultra deep memory cells.

A user or software can input commands 18 to the memory recombination controller 16 regarding the speed and direction of the object 14, the relative size of object 14 and the pixels, distance between the object 14 and the image capturing device 12 and/or operating speed of the camera. It is also within the scope of this invention for the memory recombination controller 16 to be pre-programmed with any of the aforementioned parameters if they are constant. For instance, a user can input 18 an integer or other value to indicate the speed of the object 14, using a positive or negative sign to indicate the direction of the object's 14 movement. It is also within the scope of the invention for the speed of the object to be detected automatically by, for example, a sensor, a motor on the conveyer belt, an encoder, or any timing device, and input through software or a user into the memory recombination controller 16. Input 18 may include instructions to delay all of the signals, instructions to selectively delay respective signals by different times, or both.

Responsive to user input or a pre-programmed constant, the memory recombination controller 16 then delays at least one of the unprocessed non-synchronous signals 1a, 2a, 3a to produce processed electrical signals 1b, 2b, 3b. The memory recombination controller 16 advantageously synchronizes the electrical signals. In one exemplary embodiment, memory recombination controller 16 may be a signal synchronizer. It is within the scope of the invention to delay all of the signals and/or to delay different signals at different times. For example, if the object 14 moves across the field of view of the linear photosensors 1, 2, 3, in direction 28 at a speed of 4 units per second, a user may input “4”. In response, the memory recombination controller 16 will then hold the signals 1a and 2a in a buffer until signal 3a is received. The delay of the signals will therefore be a function of the distance between the center points of the linear photosensors 1, 2, 3, the size, distance, relative speed, and direction of the object 14, and the operating speed of the camera. In one embodiment, the electrical signal 1a from the photosensor 1 that detects the object 14 first, will advantageously be delayed by memory recombination controller 16 by twice the time that signal 2a, received from the middle photosensor 2, is delayed. In one embodiment, electrical signal 1a may be delayed with respect to electrical signal 2a, by the same time that electrical signal 2a is delayed with respect to electrical signal 3a. It is also within the scope of the invention to delay the signals by different times if the spacing between the photosensors varies or to account for the photosensors including different optical-to-electrical conversion characteristics. It is a general concept of the invention that memory recombination controller 16 delays the first received signal or signals relative to the latter received signal or signals, and does so within the housing 10.

A further advantage of the present invention is that, in one embodiment, the delay can be adjusted dynamically, allowing a user or software to change the delay based on, for example, the speed, distance, size and direction of the object, the size of the pixels, the operating speed of the camera, or on a desired skewing effect.

In another exemplary embodiment in which the object 14 moves in the direction opposite direction 28, the user may input “−4” to program the memory recombination controller 16 to hold signals 2a and 3a in the buffer until signal 1a is received. Each of the preceding programming examples, including integers “+4” and “−4”, are intended to be exemplary only and speeds, time delays, programming techniques, input values and types, and relative time delays may vary in other embodiments.

If the motion of the object moving relative to the camera remains the same, the memory recombination controller 16 may be pre-programmed to effect the delay automatically without the need for any active input 18. If the relative motion between object 14 and the camera is not constant, it is also within the scope of the invention to vary the time intervals between captures according to a “line drive” signal, as is known in the art. The line drive signal is a trigger signal generated by an encoder at regular spatial intervals, referenced to the object, so that the capture times are synchronous with the movement.

If the relative motion of different image recordings for a camera changes, a user or software can input 18 the speed, distance, size, and/or direction of the object 14, size of the pixels, and/or operating speed of the device into memory recombination controller 16 to accurately determine the necessary delay. In this case, the memory recombination controller 16 may be programmable, such as an FPGA or the like. According to the various aforementioned examples, memory recombination controller 16 may be considered a delay means or a synchronizing means.

The memory recombination controller 16 then transmits the processed signals 1b, 2b, 3b to an image combiner 20. In an exemplary embodiment, processed signals 1b, 2b, 3b are synchronized. Image combiner 20 forms an image from the combined electrical signals. One skilled in the art will appreciate that image combiner 20 may be any of various suitable devices available in the art that form an image such as a visual or optical image, from the combined electrical signals. Image combiner 20 is capable of superimposing the images corresponding to the multiple electrical image signals which it receives. The composite image formed of the synchronous processed signals 1b, 2b and 3b, will advantageously be distortion-free. A composite image formed by the image combiner 20 may then be transmitted and recorded in image storage 24 and/or displayed on a display 22. The image combiner 20, storage 24, or display 22 may be located in or on the camera housing or external to the camera.

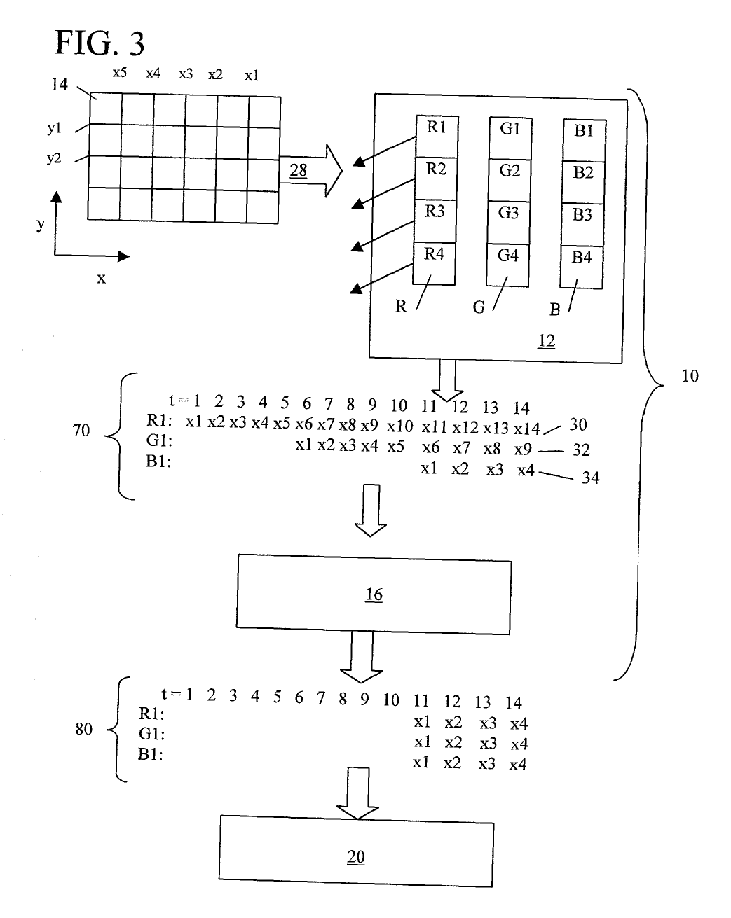

FIG. 3 shows additional details of the signal processing within the camera housing according to one embodiment of the invention. In this exemplary embodiment, image capturing device 12 includes three photosensors R, G, B, each including 4 pixel cells and capable of detecting red, green and blue light, respectively. Such is intended to be exemplary only and other arrangements may be used in other embodiments. Each of photosensors R, G, B is essentially a linear pixel array or “line” of pixels oriented essentially orthogonal to scan direction 28. Pixels R1-B4 are arranged on an image capturing device 12 within a camera housing or the like, along with memory recombination device 16. In one exemplary embodiment, the spacing between each photosensor R, G, B is equal to four times the pixel width, but one skilled in the art will recognize that other relative spacings may be used. As an object 14 is moved along the scan direction 28, and across the field of view of the photosensors R, G, B, each pixel R1-B4 generates an electrical signal, such as signal 30 from pixel R1, corresponding to the light sensed at its surface during a series of captures corresponding to various “x” locations along y=1. As time, “t”, progresses, pixel R1 will detect a different point of the object 14 as it moves with respect to image capturing device 12 along direction 28. This is true for each of pixels R1-B4.

Each pixel R1-B4 detects light values at a single, corresponding location along the y axis of object 14 and at multiple x locations as the object 14 scans with respect to image capturing device 12. For example, the object 14 may be considered divided into a grid such that y1, y2, y3, etc., are locations of small dimension (“points”) along the y direction that correspond to pixels R1, R2, R3, etc., respectively, in sensor R, pixels G1, G2, G3, etc., respectively, in sensor G, and pixels B1, B2, B3, etc., respectively, in sensor B. Each location y1, y2, y3, etc. may be infinitesimally small depending on the size and sensitivity of the pixels. As such, a single pixel R1, in this example, detects light values at locations x1, x2, x3, etc., along location y1 of the y axis. Likewise, another single pixel R2 detects light values at x1, x2, x3, etc., along location y2 of the y axis.

For each pixel such as R1, each location along the x axis is sensed at a different time since the object 14 is scanned with respect to the photosensor array R, G, B along scan direction 28 that is substantially orthogonal to each of the linear photosensors R, G, and B, in the illustrated embodiment.

Similarly, each location on object 14, for example x1, will be sensed by the corresponding pixels R1, G1, B1 at different times. In the illustrated embodiment, each of pixels R1, G1, B1 convert a sensed/captured image to an electrical signal at the same rate. Therefore, the electrical signal corresponding to the sensed image of x1 will be delivered by photosensors R, G and B at different times. This is intended to be exemplary only and the photosensors may have different conversion rates in other exemplary embodiments. Returning to the embodiment illustrated in FIG. 3, array 70 is a numerical array showing the exemplary electrical signals 30, 32 and 34 generated by pixels R1, B1, G1, respectively, for the various x locations of object 14 along y1, as a function of time. For example, at time frame t=1, x1 has been sensed (and an electrical signal generated) by pixel R1, but not yet by pixels G1 and B1. Similarly, at time frame t=2, x2 has been sensed (and an electrical signal generated) by pixel R1, but not yet by pixels G1 and B1. At time frames t=1 and t=2, pixel G1 does not detect the object at all because the object has not yet moved within the field of view of pixel G1, nor any other pixel in photosensor G or photosensor B. Finally, at time frame t=6, location (x1, y1) arrives within the field of view of pixel G1 and is detected by photosensor G, as shown by signal 32. The electrical signal corresponding to location (x1, y1) and delivered by pixel G1, lags behind the corresponding electrical signal delivered by pixel R1, by 5 time frames. Likewise, the location (x1, y1) reaches the field of view of B1 at time frame t=11.

Array 70 shows the electrical signals corresponding to locations along y1, for example, and produced by pixels R1, G1 and B1. The respective signals lag behind one another and are not synchronous. When these unprocessed electrical signals 30, 32 and 34 are joined to produce a composite image, the image will be distorted because the electrical signals corresponding to a single point (x1, y1) on object 14 are not synchronous. Unprocessed signals 1a, 2a, and 3a of FIG. 1 correspond to signals 30, 32 and 34 of array 70 of FIG. 3, respectively, for the case of one pixel photosensors.

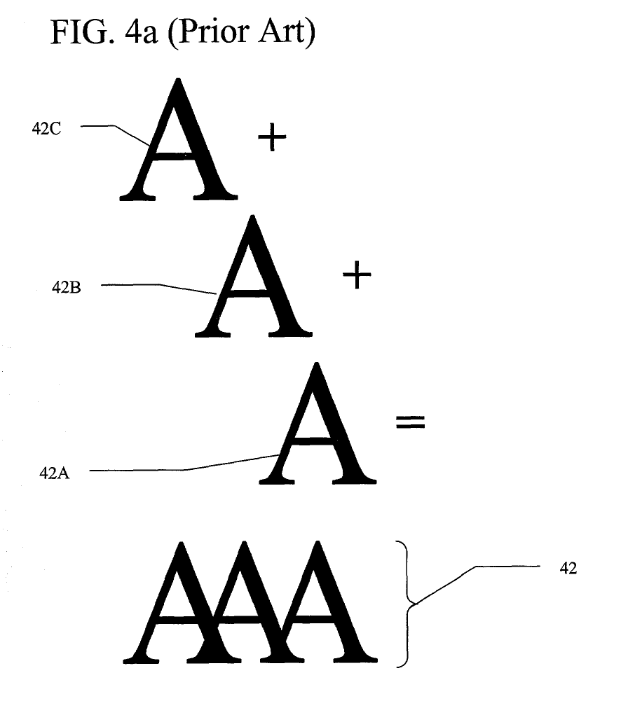

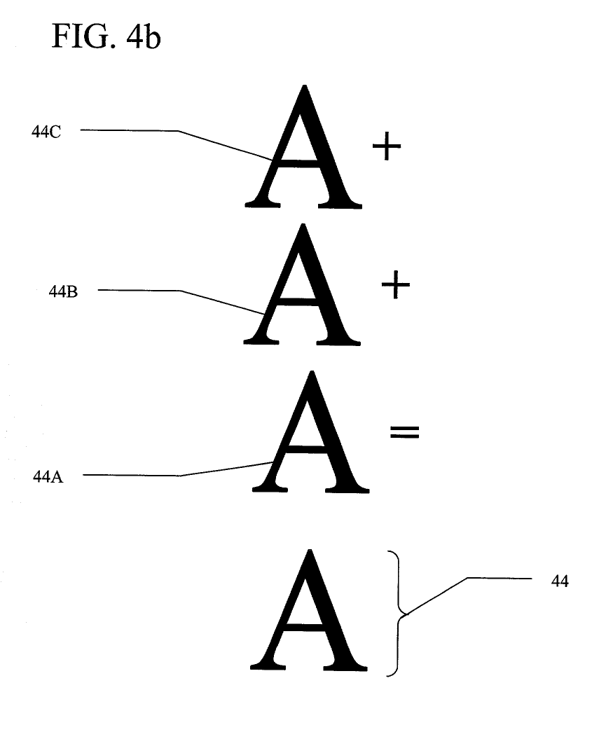

When the object 14 is scanned at constant speed, the distortion may be proportional to the spacings 50 between the sensors. For example, for location x1, the image produced by photosensor G may be displaced from the image produced by photosensor R by an amount proportional to the sum of the pixel width 60 and the pixel spacing 50 (as shown in FIG. 2). Likewise, at location x1, the image produced by photosensor B may be displaced from the image produced by photosensor R by an amount proportional to twice the sum of the pixel width 60 and the pixel spacing 50. A representation of this displacement along the scan direction of the signals, is illustrated in FIG. 4a. An exemplary composite image which may be formed by the superimposition of such unprocessed, un-synchronized signals shown in numerical array 70, is shown as distorted image 42 in FIG. 4a. FIG. 4a shows an exemplary image produced by combining the electrical signals such as the non-synchronous signals 1a, 2a and 3a shown in FIG. 1 and represented by the corresponding individual image components 42a, 42b, and 42c.

Referring again to FIG. 3, the time, “T”, required for the one point (x1, y1) on the object 14 to traverse the width of the pixel 60 and the spacing 50 is a function of both the speed and direction of the object 14. The unprocessed signals of array 70 are then transmitted to memory recombination controller 16, where the signals from the pixels in the photosensor R (R1, etc.), may be delayed by twice the time “T”. The signals from the pixels in the G photosensor, G1-G4, may be similarly delayed by time T, while the signals from the pixels on the B photosensor, B1-B4, are not delayed at all in this exemplary embodiment.

The processed signals can then be transmitted from the memory recombination controller 16 synchronized, as shown as 1b, 2b, and 3b in FIG. 1, and the signals represented by numerical array 80 in FIG. 3. The images created by the processed signals can then be combined in image combiner 20 to form an unskewed or undistorted image, such as may be stored in storage 24 and/or displayed by display 22, shown in FIG. 1. FIG. 4b shows an exemplary image 44 produced by combining the electrical signals such as the synchronized signals 1b, 2b and 3b shown in FIG. 1, and represented by the corresponding individual image components 44a, 44b, and 44c. Processed signals 1b, 2b, and 3b of FIG. 1 correspond to the signals associated with R1, G1 and B1 of numerical array 80 in FIG. 3, for the case of one pixel photosensors.

The digital image recording device of the invention may be a camera or the like, and the housing may be a conventional camera housing. Since the delay/synchronization of the electrical signals occurs within the housing, no external software or computers are needed. The processed/synchronized signals yield an undistorted image, that is, the components which combine to form the image are not skewed when the signals are combined. The internal processing of the signals within the housing, reduces costs and time, while increasing portability and convenience, as a bulky computer or the like, is not needed.

The present invention may be embodied in other specific forms without departing from the spirit or essential attributes. The illustrated embodiments should therefore be considered illustrative, and the scope of the invention is defined by the following claims.

What is claimed is:

1. A digital image recording device comprising:
a housing;
a capturing device including a plurality of photosensors spatially separated along a scan direction within the housing, each of the plurality of photosensors capable of sensing an object scanned across the capturing device and transmitting an electrical signal corresponding to the sensed object; and
delay means within the housing for delaying at least one of the transmitted electrical signals relative to another of the transmitted electrical signals.

2. The digital image recording device of claim 1, wherein the delay means is capable of delaying at least two of the transmitted electrical signals by different times.

3. The digital image recording device of claim 1, further comprising an interface coupled to the delay means and capable of receiving input and transmitting the input to the delay means, wherein the delay means is capable of selectively delaying at least one of the transmitted electrical signals responsive to the input.

4. The digital image recording device of claim 3, wherein the input corresponds to at least one of the group consisting of a speed of the object, a direction of the object, a size of the object, a distance from the object to the capturing device, a size of a pixel within at least one of the photosensors, and an operating speed of the digital image recording device.

5. The digital image recording device of claim 1, wherein the transmitted electrical signals are received by the delay means and are non-synchronous when received by the delay means.

6. The digital image recording device of claim 5, wherein the delay means is capable of delaying the at least one transmitted electrical signal such that the transmitted electrical signals are synchronous.

7. The digital image recording device of claim 1, wherein the delay means is capable of synchronizing the transmitted electrical signals.

8. The digital image recording device of claim 1, wherein each of three of the plurality of photosensors senses a different one of the group of colors consisting of red, green, and blue.

9. The digital image recording device of claim 1, wherein each of the plurality of photosensors senses a different color.

10. The digital image recording device of claim 1, wherein each of the plurality of photosensors consists of a 1 by n array of pixel cells, wherein n represents a positive integer.

11. The digital image recording device of claim 1, wherein the delay means comprises at least one field-programmable gate array.

12. The digital image recording device of claim 1, wherein the delay means includes a buffer.

13. The digital image recording device of claim 1, wherein each photosensor is a charge coupled device including a plurality of linearly arranged photosensor image resolution pixels.

14. The digital image recording device of claim 1, wherein each of the plurality of photosensors is a linear array of pixels arranged substantially orthogonally with respect to the scan direction.

15. The digital image recording device of claim 1, further comprising an image combiner capable of combining the transmitted electrical signals to form an optical image.

16. A digital camera comprising:
a housing;
a capturing device including a plurality of photosensors spatially separated from each other along a scan direction within the housing, each of the plurality of photosensors capable of sensing an image scanned across the capturing device in the scan direction, and transmitting an electrical signal corresponding to the sensed image;
synchronizing means within the housing for synchronizing the transmitted electrical signals; and
an image combiner capable of combining the transmitted electrical signals to form a generated image.

17. A method of generating a digital image comprising:
providing a housing, the housing containing a delay means and a plurality of photosensors that are spatially separated;
scanning an object across a field of view of each of the plurality of photosensors;
generating, within the housing, a plurality of electrical signals corresponding to the plurality of photosensors and associated with the object;
delaying at least one of the plurality of electrical signals with respect to another of the plurality of electrical signals, within the housing; and
combining the plurality of electrical signals after the delaying.

18. The method of claim 17, further comprising programming to select at least one of the plurality of electrical signals to be delayed.

19. The method of claim 17, further comprising programming a delay time of at least one of the plurality of electrical signals.

20. The method of claim 17, wherein the delaying includes synchronizing the plurality of electrical signals.

21. The method of claim 17, further comprising delivering the combined plurality of electrical signals to one of a recording device and a display medium, after combining the plurality of electrical signals.

22. The method of claim 18, wherein the delaying includes delaying at least two of the plurality of electrical signals by different times.

23. The method of claim 18, wherein the generating includes generating a non-synchronous plurality of electrical signals and the delaying includes synchronizing the plurality of electrical signals.

24. The method of claim 17, in which the combining includes forming an optical image of the combined electrical signals.

25. A method of generating a digital image comprising:
providing a camera including a housing, the housing containing a signal synchronizer and a plurality of photosensors that are spatially separated;
scanning an object across a field of view of each of the plurality of photosensors;
generating, within the housing, a non-synchronous plurality of electrical signals corresponding to the plurality of photosensors and associated with the object;
synchronizing the plurality of electrical signals within the housing; and
combining the plurality of synchronized electrical signals.

26. The method of claim 25, further comprising forming an image from the synchronized electrical signals.
